(19) United States
(12) Patent Application Publication
(10) Pub. No.: US 2026/0248065 A1
(43) Pub. Date: Aug. 27, 2026

(54) SOIL PARAMETER SENSING AND CONTROL SYSTEM FOR AN AGRICULTURAL SEEDER

(71) Applicants: CNH Industrial America LLC, New Holland, PA (US); CNH Industrial Canada, Ltd., Saskatoon (CA)

(72) Inventors: Brittany Ann Schroeder, Bunker Hill, IN (US); Trevor Philip Stanhope, Oak Lawn, IL (US); Dennis George Thompson, Saskatoon (CA)

(21) Appl. No.: 19/065,724

(22) Filed: Feb. 27, 2025

(51) Int. Cl. A01C 7/20; A01C 5/06; A01C 7/04; A01C 7/06; A01C 23/00

(52) U.S. Cl. CPC A01C 7/20; A01C 5/062; A01C 5/068; A01C 7/04; A01C 7/06; A01C 23/007

(57) ABSTRACT

A control system for controlling an agricultural system includes one or more sensors. Each sensor is configured to output a sensor signal. The control system also includes a first seed meter configured to meter a first seed from a first seed storage tank into a primary line and a second seed meter configured to meter a second seed from a second seed storage tank into the primary line. In addition, the control system includes a controller communicatively coupled to the sensors and seed meters. The controller is configured to receive the sensor signal from each sensor, determine the soil parameter(s) based on each sensor signal, and control the first and second seed meters to engage metering of one of the first seed or the second seed and disengage metering of the other of the first seed or the second seed based on the one or more soil parameters.

### BACKGROUND

The present disclosure relates generally to a soil parameter sensing and control system for an agricultural seeder.

Soil maps of various soil parameters may be used for controlling the agricultural seeder to enhance crop production. Soil parameter mapping may be performed by a field operation separate from seeding operations (e.g., before seeding operations begin). For example, a non-contact sensor may be installed on a vehicle such as a utility task vehicle (UTV), a pickup truck, or a drone aircraft for use in field mapping. Consequently, the data from the mapping operation is uploaded for use in the subsequent seeding operation. But soil properties may change since the field was mapped, thereby resulting in an inefficient subsequent seeding operation.

### SUMMARY

In certain embodiments, a control system for controlling an agricultural system includes one or more sensors configured to be mounted on the agricultural system. The control system also includes a first seed meter configured to meter a first seed from a first seed storage tank into a primary line at a first seed flowrate. Furthermore, the control system includes a second seed meter configured to meter a second seed, different from the first seed, from a second seed storage tank into the primary line at a second seed flowrate. In addition, the control system includes a controller communicatively coupled to the one or more sensors, to the first seed meter, and to the second seed meter. Each sensor of the one or more sensors is configured to output a sensor signal indicative of one or more soil parameters. The primary line is configured to convey the first seed and the second seed toward a row unit via an airflow through the primary line. The controller includes a processor and a memory, and the controller is configured to receive the sensor signal from each sensor of the one or more sensors, determine the one or more soil parameters based on each sensor signal, and control the first and second seed meters to engage metering of one of the first seed or the second seed and disengage metering of the other of the first seed or the second seed based on the one or more soil parameters.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system having an agricultural seeding implement and an air cart in accordance with aspects of the present disclosure;

FIG. 2 is a top view of an embodiment of the agricultural system of FIG. 1 in accordance with aspects of the present disclosure; and

FIG. 3 is a side view of an embodiment of a row unit that may be employed within the agricultural seeding implement of FIG. 1 in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

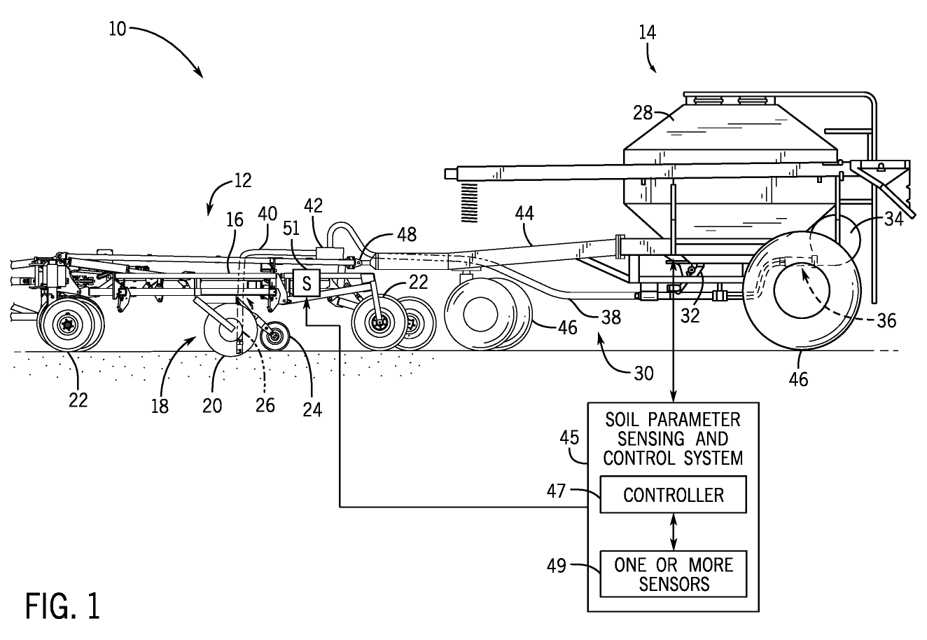

FIG. 1 is a side view of an embodiment of an agricultural system 10 having an agricultural seeding implement 12 (e.g., seeding toolbar) and an air cart 14. In the illustrated embodiment, the agricultural seeding implement 12 includes a tool frame 16, and a row unit 18, which includes an opener disk 20, is coupled to the tool frame 16. As illustrated, wheel assemblies 22 are also coupled to the tool frame 16. The agricultural seeding implement 12 may be pulled through a field by a work vehicle (e.g., a tractor, an autonomous work vehicle), and the agricultural seeding implement 12 may deposit rows of agricultural product (e.g., seed, fertilizer, inoculant, etc.) into the soil as the agricultural seeding implement 12 traverses the field. The wheel assemblies 22 contact the soil surface and enable the agricultural seeding implement 12 to be pulled by the work vehicle, and the row unit 18 may deposit one row of the agricultural product into the soil. Although only one row unit 18 is shown coupled to the tool frame 16 for clarity, the agricultural seeding implement 12 may include multiple row units 18 (e.g., organized in one or more rows across the agricultural seeding implement 12). In some embodiments, the agricultural seeding implement 12 may include 12, 14, 16, 18, 20, or more row units 18, each of which may deposit agricultural product into the soil to form a respective row.

To facilitate depositing the agricultural product within the soil, each row unit 18 includes the opener disk 20, a packer wheel 24, and at least one agricultural product tube 26. In response to movement of the row unit 18 through the field, the opener disk 20 exerts a force onto the soil that excavates a trench within the soil. As the agricultural seeding implement 12 moves through the field, the row unit 18 may deposit the agricultural product into the excavated trench via the agricultural product tube(s) 26. Then, the packer wheel 24 may pack soil onto the deposited agricultural product.

In the illustrated embodiment, the air cart 14 includes at least one storage tank 28 configured to centrally store the agricultural product. In addition, the agricultural system 10 includes distribution lines 30 configured to facilitate flow of the agricultural product to the row units 18. Furthermore, the air cart 14 includes a metering system 32 configured to control flow of the agricultural product into the distribution lines 30. The metering system may include one or more meters (e.g., fertilizer meter(s), seed meter(s), etc.). The air cart 14 also includes an air source 34 configured to provide an air flow through the distribution lines 30. The air flow interacts with the agricultural product flowing into the distribution lines 30 from the metering system 32, thereby fluidizing the agricultural product and forming an air/agricultural product mixture. The distribution lines 30 are configured to transport the air/agricultural product mixture to the row units 18, thereby providing the row units 18 with a metered flow of the agricultural product.

In the illustrated embodiment, the air cart 14 includes an air plenum 36 coupled to the air source 34. The air plenum 36 is configured to distribute the air flow provided by the air source 34 across multiple primary lines 38 of the distribution lines 30. The metering system 32 controls the flow of the agricultural product into the primary lines 38, and the air flow through the primary lines 38 fluidizes the agricultural product and conveys the agricultural product toward the row units 18. In addition, the distribution lines 30 include secondary lines 40 coupled to each primary line 38 via a respective distribution header 42. Each distribution header 42 is configured to distribute the air/agricultural product mixture provided by a respective primary line 38 to multiple secondary lines 40. In the illustrated embodiment, each secondary line 40 is coupled to a respective row unit 18. Accordingly, the agricultural product is conveyed from a storage tank 28 to the row units 18 via the primary lines 38, the distribution headers 42, and the secondary lines 40. However, in other embodiments, the agricultural system may include a secondary distribution header coupled to each secondary line, and multiple tertiary lines may be coupled to each secondary distribution header. In such embodiments, each tertiary line may be coupled to a respective row unit, such that the agricultural product is distributed via the primary lines, primary distribution headers, secondary lines, secondary distribution headers, and tertiary lines. Furthermore, in certain embodiments, the secondary lines and the distribution headers may be omitted, and the primary lines may be directly coupled from the meters to the respective row units.

In the illustrated embodiment, the air cart 14 includes an air cart frame 44 configured to support the storage tank(s) 28, the metering system 32, the air source 34, and the plenum 36. The air cart 14 also includes wheels 46 rotatably coupled to the air cart frame 44 and configured to facilitate movement of the air cart 14 through the field. In the illustrated embodiment, the air cart 14 is towed behind the agricultural seeding implement 12. Accordingly, the agricultural seeding implement 12 is coupled to the work vehicle by a first hitch assembly, and the air cart 14 is coupled to the agricultural seeding implement 12 by a second hitch assembly 48. However, in other embodiments, the agricultural seeding implement may be towed behind the air cart. In further embodiments, the agricultural seeding implement and the air cart may be part of a single unit that is towed behind a work vehicle, or the agricultural seeding implement and the air cart may be elements of a self-propelled vehicle.

In the illustrated embodiment, the agricultural system 10 includes a soil parameter sensing and control system 45, and the soil parameter sensing and control system 45 includes a controller 47. The controller 47 is configured to control the metering system 32. As previously discussed, the storage tank(s) 28 are configured to provide the agricultural product to the metering system 32, and the metering system 32 is configured to control an agricultural product flowrate of the agricultural product into each primary line 38. Accordingly, the controller 47 is configured to control the metering system 32 to control the agricultural product flowrate of the agricultural product into each primary line 38.

In the illustrated embodiment, the soil parameter sensing and control system 45 includes one or more sensors 49. As illustrated in FIG. 1, the one or more sensors 49 include a non-contact sensor 51. Each non-contact sensor 51 is configured to monitor one or more parameters of the soil. In addition, each non-contact sensor 51 may include a gamma ray spectrometer, an electrical conductivity (EC) sensor, a ground penetrating radar (GPR), an electromagnetic interference (EMI) sensor, other suitable non-contact sensing device(s), or a combination thereof. The sensor(s) 49 may be mounted on the tool frame 16 and/or the air cart frame 44 (collectively, the frame) of the agricultural system 10, the work vehicle, the storage tank(s) 28, the distribution header(s) 42, other component(s) of the agricultural system 10, or a combination thereof. The sensor(s) 49 may be mounted at the row units 18, in front of the row units 18, behind the row units 18, or a combination thereof. For example, a non-contact sensor 51 may be mounted on a row unit 18 and/or on the agricultural seeding implement 12. The non-contact sensor 51 mounted on the agricultural seeding implement 12 may be mounted in front of, behind, or proximate to the row units 18. In some embodiments, the sensor(s) 49 include a single sensor mounted to the agricultural system 10 and configured to measure soil parameter(s) of the field for the entire working width of the agricultural seeding implement 12 or for a portion of the entire working width of the agricultural seeding implement 12. Furthermore, the sensor(s) 49 may include multiple sensors, each of which is configured to measure soil parameter(s) of the field for a portion of the working width of the agricultural system 10. For example, a sensor 49 may be mounted at, in front of, or behind each row unit 18 such that each sensor measures soil parameter(s) of the field for the swath of the field that is engaged by the respective row unit 18. In certain embodiments, the sensors 49 may include a sensor array. Furthermore, in certain embodiments, the sensors 49 may be mounted at different heights above the ground. In some embodiments, the sensors 49 may be mounted on a drone configured to fly in front of, alongside, or behind the agricultural seeding implement 12.

Each sensor 49 is configured to output a sensor signal indicative of the one or more soil parameters, and the controller 47 is configured to receive the sensor signal from each sensor 49. The controller 47 is configured to determine one or more soil parameters based on feedback from the sensor(s) 49. The soil parameters may include moisture, macro-nutrient/micro-nutrient levels (e.g., nitrogen, phosphorus, potassium, etc.), texture, pH, cation exchange capacity (CEC), organic matter levels, compaction, residue levels, salinity, temperature, other suitable parameter(s), or a combination thereof. For example, the sensor(s) 49 (e.g., GPR sensor(s), etc.) may output sensor signal(s) indicative of subsurface image(s) of the field. The controller 47 may determine the texture of the soil based on an analysis of the subsurface image(s). In embodiments in which the sensors 49 include the sensor array, the sensors 49 may monitor a gradient of the soil parameter(s) (e.g., along the width of the agricultural seeding implement 12 and/or at a range of soil depths below the implement).

In some embodiments, the controller 47 is configured to control operation of the agricultural system 10 during the seeding operation based on the one or more parameters of the soil to enhance crop development. In certain embodiments, the controller 47 receives the sensor feedback for a particular area of soil, determines one or more soil parameters of the particular area of soil, and controls operation of the agricultural system 10 based on the one or more soil parameters while the agricultural seeding implement 12 is travelling over the particular area of soil. In embodiments in which the sensor(s) 49 are mounted on the drone, the sensor(s) on the drone provide the sensor feedback to the controller during the seeding operation. The controller 47 may control a flowrate of fertilizer from the metering system 32, a flowrate of a first seed from the metering system 32, a flowrate of a second seed from the metering system 32, a packing force applied by each packer wheel 24, the downforce applied by each opener disk 20, or any combination thereof. For example, the controller 47 may control the metering system 32 to increase the flowrate of fertilizer in response to determining the one or more soil parameters indicate the nutrient level of the soil (e.g., a particular nutrient level of the soil) is low. As another example, the controller 47 may control actuator(s) to apply greater downforce in response to determining the one or more soil parameters indicate the soil has a higher compaction level. In some embodiments, the controller 47 may adjust the operation of the agricultural system 10 based on the type of fertilizer (e.g., liquid/solid, organic/inorganic, composition, slow-release, etc.) in a fertilizer storage tank 28 and/or the type of seeds in the first seed storage tank 28 and/or the second seed storage tank 28. The controller 47 may access database(s) to determine the characteristics (e.g., properties) of different types of seeds and/or fertilizers. The controller 47 may then adjust operation of the agricultural system 10 to enhance crop development. For example, the controller 47 may use the database(s) to determine that a first seed variety in the first seed storage tank 28 grows well in moist (e.g., high moisture) conditions and a second seed variety in the second seed storage tank 28 grows well in dry (e.g., low moisture) conditions. Based on that determination, the controller 47 may control the seed meter 32 to engage flow of the first seed in high-moisture areas while disengaging flow of the second seed in the high-moisture areas. In addition, the controller 47 may control the seed meter 32 to engage flow of the second seed in low-moisture areas while disengaging flow of the first seed in the low-moisture areas.

In some embodiments, the controller 47 generates a soil map based on the sensor feedback from the sensor(s) 49. If a soil map has already been created for the field, the controller 47 may update the soil map based on the sensor feedback. The soil map may include multiple layers, and each layer may contain information regarding one of the one or more soil parameters. For example, the map may include a first layer containing information regarding moisture of the soil and a second layer containing information regarding the nutrient level of the soil. The soil map may include the one or more soil parameters as gradients. The controller 47 may communicate the soil map via a suitable connection to a central computing system and/or to the computing system(s) of other agricultural device(s) (e.g., a harvester, a tractor) for use in additional agricultural operation(s) (e.g., subsequent agricultural operations(s)). The controller 47 may also control a user interface to present the soil map on a display of the user interface for an operator of the agricultural system.

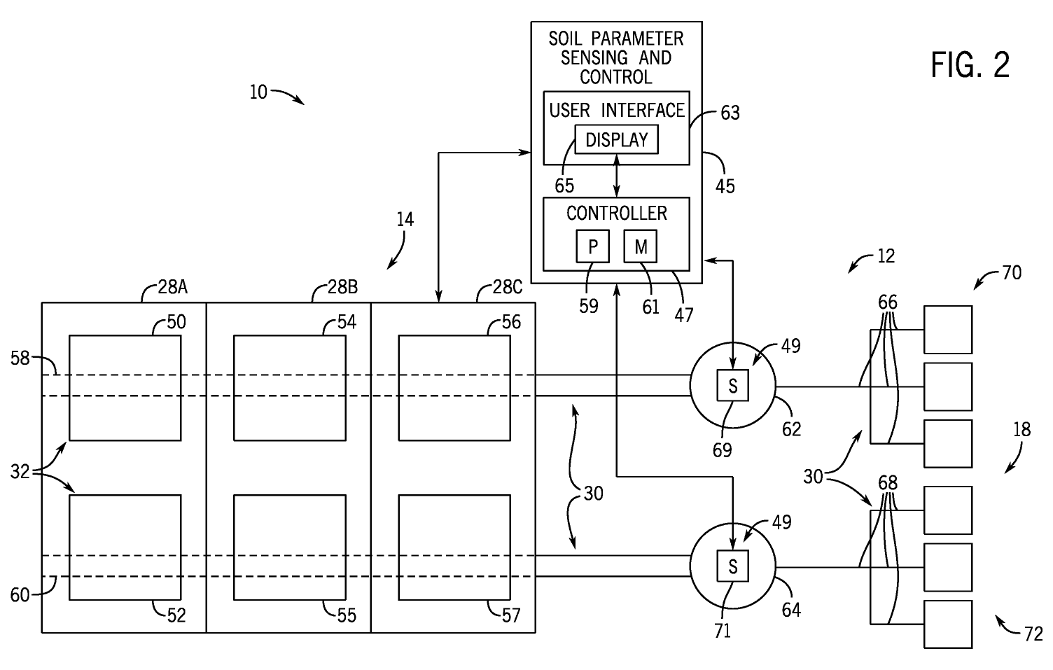

FIG. 2 is a top view of an embodiment of the agricultural system 10 of FIG. 1. As previously discussed, the agricultural system 10 includes an air cart 14 and an agricultural seeding implement 12. The air cart 14 includes a fertilizer storage tank 28A, a first seed storage tank 28B containing a first seed, and a second seed storage tank 28C containing a second seed. The first seed may be the same type of seed or a different type of seed from the second seed. In some embodiments, the first seed and the second seed may be seeds for different varieties of the same plant. The different varieties may have different properties. The properties may include suitability of the seed for different soil conditions (e.g., soil moisture, texture, compaction, composition, pH, etc.). For example, the first seed may have properties suitable for development in high-moisture soil, and the second seed may have properties suitable for development in low-moisture soil. In the illustrated embodiment, the metering system 32 of the air cart 14 includes a first fertilizer meter 50, a second fertilizer meter 52, a first seed meter 54, a second seed meter 55, a third seed meter 56 (e.g., second seed meter), and a fourth seed meter 57. The first fertilizer meter 50 dispenses fertilizer from the fertilizer storage tank 28A into a first primary line 58 of the distribution lines 30, the first seed meter 54 dispenses the first seed from the first seed storage tank 28B into the first primary line 58, and the third seed meter 56 dispenses the second seed from the second seed storage tank 28C into the first primary line 58. Likewise, the second fertilizer meter 52 dispenses fertilizer from the fertilizer storage tank 28A into a second primary line 60 of the distribution lines 30, the second seed meter 55 dispenses the first seed from the first seed storage tank 28B into the second primary line 60, and the fourth seed meter 57 dispenses the second seed from the second seed storage tank 28C into the second primary line 60. However, in certain embodiments, the metering system may include one meter per storage tank configured to dispense agricultural product from the respective storage tank, or the metering system may include three or more meters per storage tank configured to dispense agricultural product from the respective storage tank.

In the illustrated embodiment, the first primary line 58 feeds into a first distribution header 62. The first header 62 outputs the fertilizer, the first seed, the second seed, or any combination thereof, into first secondary lines 66. The first secondary lines 66 feed the fertilizer and/or the seed(s) to a first set 70 of row units 18 for distribution. Similarly, the second primary line 60 feeds into a second header 64. The second header 64 outputs the fertilizer, the first seed, the second seed, or any combination thereof, into second secondary lines 68. The second secondary lines 68 feed the fertilizer and/or the seed(s) to a second set 72 of row units 18 for distribution. Although the agricultural seeding implement includes three row units and secondary lines per header, in some embodiments, the agricultural seeding implement may include more or fewer row units and secondary lines per header.

A first sensor 69 of the sensor(s) 49 is mounted in a location to measure the soil parameter(s) for a first area of the field (i.e., the area of the field traversed by the first set 70 of row units 18). Similarly, the second sensor 71 of the sensor(s) 49 is mounted in a location to measure the soil parameter(s) for a second area of the field (i.e., the area of the field traversed by the second set 72 of row units 18). For example, in the illustrated embodiment, the first sensor 69 is mounted to the first header 62, and the second sensor 71 is mounted to the second header 64. Thus, the soil parameter(s) measured by the first sensor 69 may be different than the soil parameter(s) measured by the second sensor 71. The first sensor 69 may include a contact sensor and/or a non-contact sensor, and the second sensor 71 may include a contact sensor and/or a non-contact sensor.

In the illustrated embodiment, the controller 47 is communicatively coupled to the sensor(s) 49 (e.g., the first sensor 69 and the second sensor 71) and to the metering system 32. In certain embodiments, the controller 47 is an electronic controller having electrical circuitry configured to control the metering system 32. In the illustrated embodiment, the controller 47 includes a processor 59, such as the illustrated microprocessor, and a memory device 61. The controller 47 may also include one or more storage devices and/or other suitable components. The processor 59 may be used to execute software, such as software for controlling the metering system 32, and so forth. Moreover, the processor 59 may include multiple microprocessors, one or more “general-purpose” microprocessors, one or more special-purpose microprocessors, and/or one or more application specific integrated circuits (ASICs), or some combination thereof. For example, the processor 59 may include one or more reduced instruction set (RISC) processors.

The memory device 61 may include a volatile memory, such as random access memory (RAM), and/or a nonvolatile memory, such as read-only memory (ROM). The memory device 61 may store a variety of information and may be used for various purposes. For example, the memory device 61 may store processor-executable instructions (e.g., firmware or software) for the processor 59 to execute, such as instructions for controlling the metering system 32, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the metering system 32, etc.), and any other suitable data. The controller may be positioned at any suitable location(s) on the agricultural system (e.g., as one element in one location or as multiple elements in multiple locations).

In the illustrated embodiment, the soil parameter sensing and control system 45 includes a user interface 63 communicatively coupled to the controller 47. The user interface 63 is configured to receive input from an operator and to provide information to the operator. The user interface 63 may include any suitable input device(s) for receiving input, such as a keyboard, a mouse, button(s), switch(es), knob(s), other suitable input device(s), or a combination thereof. In addition, the user interface 63 may include any suitable output device(s) for presenting information to the operator, such as speaker(s), indicator light(s), other suitable output device(s), or a combination thereof. In the illustrated embodiment, the user interface 63 includes a display 65 configured to present visual information to the operator. In certain embodiments, the display 65 may include a touchscreen interface configured to receive input from the operator.

The controller 47 is configured to control operation of the first fertilizer meter 50, the first seed meter 54, and the third seed meter 56 based on the soil parameter(s) measured by the first sensor 69. The controller 47 is also configured to control operation of the second fertilizer meter 52, the second seed meter 55, and the fourth seed meter 57 based on the soil parameter(s) measured by the second sensor 71. Thus, the controller 47 is configured to control the flowrate of the fertilizer through the first fertilizer meter 50, the flowrate of the first seed through the first seed meter 54, and the flowrate of the second seed through the third seed meter 56 independently of the flowrate of the fertilizer through the second fertilizer meter 52, the flowrate of the first seed through the second seed meter 55, and the flowrate of the second seed through the fourth seed meter 57. For example, the controller 47 may concurrently decrease the flowrate of the fertilizer through the first fertilizer meter 50 based on sensor feedback from the first sensor indicating high nutrient levels and increase the flowrate of the fertilizer through the second fertilizer meter based on sensor feedback from the second sensor indicating low nutrient levels.

In some embodiments, the controller 47 may control the first seed meter 54 and the third seed meter 56 to engage metering of one of the first seed or the second seed and disengage metering of the other of the first seed or the second seed based on the soil parameter(s) at the first area of the field. In addition, the controller 47 may control the second seed meter 55 and the fourth seed meter 57 to engage metering of one of the first seed or the second seed and disengage metering of the other of the first seed or the second seed based on the soil parameter(s) at the second area of the field. For example, the controller 47 may compare the property/properties of the first seed and the property/properties of the second seed to determine which seed is suitable for a particular area of the field based on the soil parameter(s) at the area. In some embodiments, the controller 47 may compare the property/properties of each seed to determine which seed is more suitable for the soil parameter(s) and select which seed to dispense based on the comparison. For example, the controller may select the seed having a target parameter closest to the determined soil parameter. By way of example, the target soil salinity for the first seed may be 6 dS/m, and the target soil salinity for the second seed may be 12 dS/m. If the soil salinity at an area is 5 dS/m, the controller 47 may select the first seed to be dispensed within the area. However, if the soil salinity at an area is 10 dS/m, the controller 47 may select the second seed to be dispensed within the area. Additionally and/or alternatively, the controller 47 may compare a minimum and/or a maximum parameter to the determined soil parameter. For example, the first seed may have a suitable pH range of 6.0 to 7.5, and the second seed may have a suitable pH range of 5.7 to 6.5. The controller 47 may select the first seed to be dispensed in an area with a pH of 7.1.

The first seed meter 54 and the third seed meter 56 may be controlled independently of the second seed meter 55 and the fourth seed meter 57. Additionally, the first seed meter 54 may be controlled independently of the third seed meter 56, and the second seed meter 55 may be controlled independently of the fourth seed meter 57. For example, the controller 47 may control the first seed meter 54 to dispense the first seed into the first primary line 58 and control the third seed meter 56 to terminate operation (e.g., stop dispensing the second seed). Concurrently, the controller 47 may control the second seed meter 55 to terminate operation (e.g., stop dispensing the first seed) and control the fourth seed meter 57 to dispense the second seed into the second primary line 60.

The controller may control the seed flow rate from the first seed meter 54 based on the soil parameter(s) at the first area while metering the first seed from the first seed meter is engaged, the controller may control the seed flowrate from the second seed meter 55 based on the soil parameter(s) at the second area while metering the first seed from the second seed meter is engaged, the controller may control the seed flowrate from the third seed meter 56 based on the soil parameter(s) at the first area while metering the second seed from the third seed meter is engaged, and the controller may control the seed flowrate from the fourth seed meter 57 based on the soil parameter(s) at the second area while metering the second seed from the fourth seed meter is engaged. Furthermore, in some embodiments, the first seed meter 54 and the third seed meter 56 may concurrently dispense the first seed and the second seed into the first primary line 58. In addition, the second seed meter 55 and the fourth seed meter 57 may concurrently dispense the first seed and the second seed into the second primary line 60. In some embodiments, the controller 47 may be configured to maintain the overall flowrate of seeds; as such, the controller may increase the flowrate of the first seed when decreasing the flowrate of the second seed and increase the flowrate of the second seed when decreasing the flowrate of the first seed.

In some embodiments, the fertilizer meters may dispense fertilizer into fertilizer primary lines coupled fertilizer headers configured to output the fertilizer into fertilizer secondary lines. In addition, the seed meters may dispense seeds into seed primary lines coupled to seed headers configured to output the seeds into seed secondary lines. The fertilizer primary lines, the fertilizer headers, and the fertilizer secondary lines may each be separate from the seed primary lines, the seed headers, and the seed secondary lines. Each row unit may include a fertilizer tube coupled to a respective fertilizer secondary line and a seed tube coupled to a respective seed secondary line, such that each row unit dispenses fertilizer and seeds.

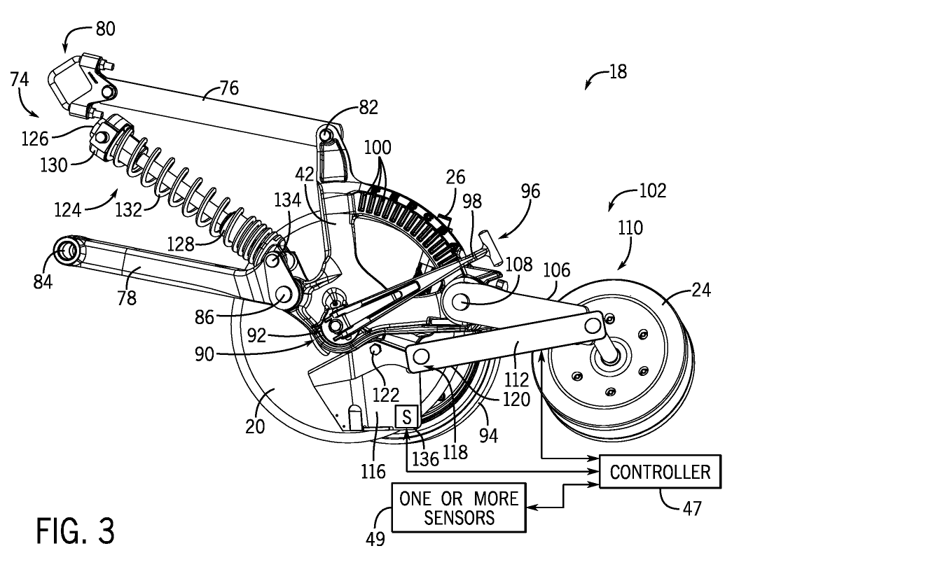

FIG. 3 is a side view of an embodiment of a row unit 18 (e.g., agricultural row unit) that may be employed within the agricultural seeding implement of FIG. 1. In the illustrated embodiment, the row unit 18 includes a linkage assembly 74 configured to couple the row unit 18 to a respective toolbar of the agricultural implement. The linkage assembly 74 includes an upper link 76 and a lower link 78. A mount 80 is positioned at a first end of the upper link 76 and is configured to couple to the respective toolbar of the agricultural implement. In addition, a second end of the upper link 76 is coupled to the frame 42 of the row unit 18 by a fastener 82. The lower link 78 includes an opening 84 configured to receive a fastener that rotatably couples the lower link 78 to the respective toolbar. In addition, a second end of the lower link 78 is rotatably coupled to the frame 42 of the row unit by a fastener 86. The linkage assembly 74 enables the frame 42 of the row unit 18 to move vertically (e.g., raise and lower) relative to the respective toolbar (e.g., in response to obstructions or variations in the terrain, for raising the row unit frame for transport, etc.). While the linkage assembly 74 includes the upper link 76 and the lower link 78 in the illustrated embodiment, in other embodiments, the row unit may include any other suitable linkage configuration to facilitate vertical movement of the row unit frame relative to the respective toolbar.

In the illustrated embodiment, the row unit 18 includes an opener disk 20 (e.g., opener disc) rotatably and non-movably coupled to the frame 42 by a bearing assembly 90. The bearing assembly 90 enables the opener disk 20 to freely rotate as the opener engages the soil, thereby enabling the opener disk 20 to excavate a trench within the soil. While the row unit 18 includes an opener disc in the illustrated embodiment, in other embodiments, the row unit may include another suitable opener (e.g., shank, point, etc.) configured to excavate a trench within the soil. The bearing assembly 90 includes a shaft 92 about which the opener disk 20 rotates.

In the illustrated embodiment, the row unit 18 includes a gauge wheel 94 configured to control a penetration depth of the opener disk 20 into the soil. The gauge wheel 94 is configured to rotate along the surface of the soil. Accordingly, adjusting the vertical position of the gauge wheel 94 relative to the frame 42 controls the penetration depth of the opener disk 20 into the soil. The gauge wheel 94 is rotatably coupled to a gauge wheel support arm, and the gauge wheel support arm is pivotally coupled to the frame 42. Accordingly, pivoting of the gauge wheel support arm drives the gauge wheel 94 to move vertically relative to the frame 42. In certain embodiments, the gauge wheel 94 is positioned against the opener disk 20 to remove soil from a side of the opener disk 20 during operation of the row unit 18.

The row unit 18 includes a depth adjustment assembly 96 configured to control the vertical position of the gauge wheel 94, thereby controlling the penetration depth of the opener disk 20 into the soil. In the illustrated embodiment, the depth adjustment assembly 96 includes a depth adjustment handle 98 and depth gauge notches 100. The depth adjustment handle 98 is non-rotatably coupled to the gauge wheel support arm and configured to drive the gauge wheel support arm to pivot about a pivot point, thereby controlling the vertical position of the gauge wheel 94 relative to the frame 42/opener disk 20. The depth adjustment handle 98 may be moved to any of the depth gauge notches 100 to adjust the vertical position of the gauge wheel 94. The depth gauge notches 100 block rotation of the depth adjustment handle 98, thereby maintaining the vertical position of the gauge wheel 94 (e.g., substantially fixing the position of the gauge wheel 94 relative to the frame 42). To adjust the vertical position of the gauge wheel 94/penetration depth of the opener disk 20, the depth adjustment handle 98 may be moved away from the depth gauge notches 100, thereby facilitating rotation of the depth adjustment handle 98 along the depth gauge notches 100. Upon release of the depth adjustment handle 98, a biasing member may urge the depth adjustment handle 98 to engage the depth gauge notches 100, thereby blocking rotation of the depth gauge handle 98 among the depth gauge notches 100. In some embodiments, the depth adjustment assembly 96 may include a depth adjustment actuator configured to control the penetration depth of the opener disk 20 into the soil. The depth adjustment actuator may be communicatively coupled to the controller 47 such that the controller 47 may control the penetration depth of the opener disk 20 into the soil. While the vertical position of the gauge wheel/penetration depth of the opener is controlled by the depth adjustment handle in the illustrated embodiment, in other embodiments, another suitable device may be used to control the vertical position of the gauge wheel/penetration depth of the opener.

In the illustrated embodiment, the row unit 18 includes a packer wheel assembly 102 having a packer wheel 24 and a support arm 106. The support arm 106 is pivotally coupled to the frame 42 by a fastener 108, and the packer wheel 24 is rotatably coupled to the support arm 106. The packer wheel 24 is configured to move the soil back into an exposed soil furrow and pack soil on top of the deposited agricultural product (e.g., to facilitate development of the resulting agricultural crop). The force applied by the packer wheel 24 to the soil surface may be adjusted via an adjustment assembly 110. The adjustment assembly 110 includes a packer wheel actuator 112 configured to urge the support arm 106 to rotate relative to the frame 42. As a result, the packer wheel actuator 112 may control the downforce applied by the packer wheel 24 to the soil. The packing wheel actuator 112 of the adjustment assembly 110 is communicatively coupled to the controller 47, such that the controller 47 may control the downforce applied by the packer wheel 24. While the row unit includes the packer wheel assembly 102 in the illustrated embodiment, in other embodiments, the packer wheel assembly may be omitted.

In the illustrated embodiment, the row unit 18 includes a scraper 116 disposed adjacent to the opener disk 20 and configured to remove accumulated soil from the opener disk 20. As illustrated, a mounting portion 118 of the scraper 116 is rigidly coupled to a mounting bracket 120 by fasteners 122. In alternative embodiments, the scraper may be coupled directly to the frame, or the scraper may be mounted to another suitable mounting structure. In the illustrated embodiment, the mounting bracket 120 is pivotally coupled to the frame 42 by a shaft, and a biasing member urges the bracket 120/scraper 116 toward the opener disk 20, thereby facilitating debris removal. While the illustrated row unit includes a scraper, in other embodiments, the scraper may be omitted. Furthermore, the row unit 18 includes an agricultural product tube 26 (e.g., seed tube) configured to direct agricultural product into the trench formed by the opener disk 20.

The row unit 18 includes a spring assembly 124 configured to facilitate upward vertical movement of the frame 42 (e.g., in response to contact between the opener disk 20 and an obstruction within the field). In the illustrated embodiment, the spring assembly 124 includes a bolt/tube assembly 126 that connects a lower trunnion 128 to an upper trunnion 130. The bolt/tube assembly 126 and lower trunnion 128 are surrounded by a compression spring 132. In addition, the spring assembly 124 is rotatably coupled to the lower link 78 by a fastener 134 to enable the spring assembly 124 to rotate relative to the lower link 78. In certain embodiments, a downforce actuator is configured to compress the spring assemblies of a group of row units. The force applied by the downforce actuator may be controlled to control the downforce applied by the gauge wheel 94 to the soil surface (e.g., while compressing the spring 132). For example, the downforce actuator may be communicatively coupled to the controller 47 such that the controller 47 may control the downforce applied by the gauge wheel 94 to the soil surface. In addition, the spring 132 is configured to compress to facilitate upward vertical movement of the frame 42 in response to the opener disk 20 or the gauge wheel 94 encountering an obstruction (e.g., rock, branch, etc.) within the field. While the row unit includes the spring assembly in the illustrated embodiment, in other embodiments, the spring assembly may be omitted. For example, in certain embodiments, the spring assembly may be omitted, and a downforce actuator may extend from the toolbar to the row unit (e.g., to the frame of the row unit, to a link of the linkage assembly, etc.).

As illustrated in FIG. 3, the one or more sensors 49 include a contact sensor 136. The contact sensor may include an optical (IR/NIR) sensor, a direct contact electrical conductivity sensor, a capacitance sensor, an ion-selective electrode (ISE) sensor, a thermocouple, a dielectric sensor, other suitable type(s) of sensing device(s), or a combination thereof. The contact sensor 136 may be mounted on any ground engaging component of the agricultural system. For example, in the illustrated embodiment, the contact sensor 136 is mounted on the scraper 116. In particular, the contact sensor 136 may be mounted on a ground engaging component of the row unit 18 and/or on a ground engaging component of the agricultural seeding implement. In some embodiments, the contact sensor 136 mounted on the ground engaging component of the agricultural seeding implement may be mounted in front of, behind, or proximate to the row unit 18. As previously discussed, the sensor(s) 49 may include multiple sensors. For example, one or more sensors 49 may be mounted in front of each row unit 18 of the agricultural system 10. As another example, the agricultural system may include groups of two or more row units 18, and the contact sensor 136 may be mounted on one row unit 18 of each group. Each group of two or more row units 18 may include row units 18 configured to receive agricultural product from a common header.

The sensor(s) 49 provide sensor feedback of the measurements of the one or more soil parameters to the controller 47 during operation of the agricultural system. The controller 47 determines one or more soil parameters based on the sensor feedback. The soil parameters may include moisture, macro-nutrient/micro-nutrient levels (e.g., nitrogen, phosphorus, potassium, etc.), texture, pH, cation exchange capacity (CEC), organic matter, compaction, residue levels, salinity, and temperature.

In some embodiments, the controller 47 controls operation of the agricultural system based on the one or more parameters of the soil during operation of the agricultural system to enhance crop development. In certain embodiments, the controller 47 receives the sensor feedback for a particular area of soil, determines one or more soil parameters of the particular area of soil, and controls operation of the agricultural system based on the one or more soil parameters while the agricultural seeding implement is travelling over the particular area of soil. The controller 47 may control a flowrate of fertilizer from the metering system 32, a flowrate of the first seed from the metering system 32, a flowrate of the second seed from the metering system 32, a packing force applied by the packer wheel 24, a downforce applied by the opener disk 20, a penetration depth of the opener disk 20, or any combination thereof. For example, in some embodiments, the controller may control operation of the agricultural system based on the properties of the first seed, the properties of the second seed, and the one or more soil parameters.

In embodiments in which a sensor 49 is mounted on one row unit 18 of each group of row units 18, the controller 47 may control the one or more components of each row unit of the group of row units 18 based on the sensor feedback from the sensor 49 mounted on the one row unit 18. Additionally, in embodiments in which the row units 18 are grouped based on receiving agricultural product from a common header, the controller 47 may independently control the fertilizer meter and/or the seed meters that provides agricultural product to the common header based on the sensor feedback from the sensor 49 mounted on the one row unit 18. For example, the controller 47 may control the flowrate of seeds from the first seed meter through the first header to the first group of row units 18 and separately control the flowrate of seeds from the second seed meter through the second header to the second group of row units 18.

In some embodiments, at least one sensor 49 may be mounted on each row unit 18 of the agricultural system. The controller 47 may group the row units 18 based on receiving agricultural products from a common header (e.g., a first row unit 18 and a second row unit 18 receive agricultural product from a first header and are, therefore, grouped together). The controller 47 may average the values of each soil parameter measured at each row unit 18 of a group of row units 18. The controller 47 may use the averaged value(s) of the soil parameter(s) to control the operation of the fertilizer meter and/or the seed meters associated with the group of row units 18. Additionally, the controller 47 may use the averaged value(s) of the soil parameter(s) to control the downforce of the packer wheel of each row unit 18 of the group of row units 18.

In some embodiments, the controller 47 generates a soil map based on the sensor feedback from the sensor(s) 49. If a soil map has already been created for the field, the controller 47 may update the soil map based on the sensor feedback. The controller 47 may use the position of the agricultural system from a spatial locating device (e.g., GPS) in combination with the sensor feedback from the sensor(s) to generate or update the soil map. The soil map may include multiple layers, and each layer may contain information regarding one of the one or more soil parameters. The soil map may include the one or more soil parameters as gradients. The controller 47 may communicate the soil map via suitable connection to a central computing system and/or to the computing system(s) of other agricultural device(s) (e.g., a harvester, a tractor). The controller 47 may also control the user interface to present the soil map on the display of the user interface for the operator of the agricultural system.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function)…” or “step for (perform)ing (a function)…”, it is intended that such elements are to be interpreted under 35 U.S.C. 112(f). However, for any claims containing elements designated in any other manner, it is intended that such elements are not to be interpreted under 35 U.S.C. 112(f).

1. A control system for controlling an agricultural system, comprising:
one or more sensors configured to be mounted on the agricultural system, wherein each sensor of the one or more sensors is configured to output a sensor signal indicative of one or more soil parameters;
a first seed meter configured to meter a first seed from a first seed storage tank into a primary line at a first seed flowrate, wherein the primary line is configured to convey the first seed toward a row unit via an airflow through the primary line;
a second seed meter configured to meter a second seed, different from the first seed, from a second seed storage tank into the primary line at a second seed flowrate, wherein the primary line is configured to convey the second seed toward the row unit via the airflow through the primary line; and
a controller communicatively coupled to the one or more sensors, to the first seed meter, and to the second seed meter, wherein the controller comprises a processor and a memory, and the controller is configured to:
receive the sensor signal from each sensor of the one or more sensors;
determine the one or more soil parameters based on each sensor signal; and
control the first and second seed meters to engage metering of one of the first seed or the second seed and disengage metering of the other of the first seed or the second seed based on the one or more soil parameters.

2. The control system of claim 1, wherein the one or more sensors comprise a non-contact sensor.

3. The control system of claim 1, wherein the one or more sensors comprise a contact sensor configured to be mounted on at least one ground-engaging tool of the agricultural system.

4. The control system of claim 1, wherein the controller is configured to generate a field map based on the one or more soil parameters.

5. The control system of claim 1, comprising a fertilizer meter configured to meter fertilizer from a fertilizer storage tank into the primary line at a fertilizer flowrate, wherein the controller is communicatively coupled to the fertilizer meter, and the controller is configured to control the fertilizer flowrate based on the one or more soil parameters.

6. The control system of claim 1, wherein the one or more soil parameters comprise macro-nutrient level, micro-nutrient level, or a combination thereof.

7. The control system of claim 1, wherein the one or more soil parameters comprise moisture, texture, pH, cation exchange capacity, organic matter, compaction, residue levels, salinity, temperature, or any combination thereof.

8. The control system of claim 1, wherein the controller is configured to:
control the first seed flowrate based on the one or more soil parameters while metering of the first seed is engaged; and
control the second seed flowrate based on the one or more soil parameters while metering of the second seed is engaged.

9. The control system of claim 1, wherein the one or more sensors comprise a sensor array configured to measure a gradient of the one or more soil parameters.

10. A control system for controlling an agricultural system, comprising:
a first sensor configured to be mounted on the agricultural system, wherein the first sensor is configured to output a first sensor signal indicative of one or more first soil parameters at a first row unit;
a second sensor configured to be mounted on the agricultural system, wherein the second sensor is configured to output a second sensor signal indicative of one or more second soil parameters at a second row unit;
a first seed meter configured to meter a first seed from a first seed storage tank into a first primary line at a first seed flowrate, wherein the first primary line is configured to convey the first seed toward the first row unit via an airflow through the first primary line;
a second seed meter configured to meter the first seed from the first seed storage tank into a second primary line at a second seed flowrate, wherein the second primary line is configured to convey the first seed toward the second row unit via an airflow through the second primary line;
a third seed meter configured to meter a second seed, different from the first seed, from a second seed storage tank into the first primary line at a third seed flowrate, wherein the first primary line is configured to convey the second seed toward the first row unit via the airflow through the first primary line;
a fourth seed meter configured to meter the second seed from the second seed storage tank into the second primary line at a fourth seed flowrate, wherein the second primary line is configured to convey the second seed toward the second row unit via the airflow through the second primary line; and
a controller communicatively coupled to the first sensor, to the second sensor, to the first seed meter, to the second seed meter, to the third seed meter, and to the fourth seed meter, wherein the controller comprises a processor and a memory, and the controller is configured to:
receive the first sensor signal from the first sensor;
determine the one or more first soil parameters at the first row unit based on the first sensor signal;
control the first and third seed meters to engage metering of one of the first seed or the second seed and disengage metering of the other of the first seed or the second seed based on the one or more first soil parameters;
receive the second sensor signal from the second sensor;
determine the one or more second soil parameters at the second row unit based on the second sensor signal; and
control the second and fourth seed meters to engage metering of one of the first seed or the second seed and disengage metering of the other of the first seed or the second seed based on the one or more second soil parameters.

11. The control system of claim 10, comprising:
a first fertilizer meter configured to meter fertilizer from a fertilizer storage tank into the first primary line at a first fertilizer flowrate; and
a second fertilizer meter configured to meter the fertilizer from the fertilizer storage tank into the second primary line at a second fertilizer flowrate;
wherein the controller is communicatively coupled to the first and second fertilizer meters, and the controller is configured to:
control the first fertilizer flowrate based on the one or more first soil parameters at the first row unit; and
control the second fertilizer flowrate based on the one or more second soil parameters at the second row unit, wherein the first fertilizer flowrate is controllable independently of the second fertilizer flowrate.

12. The control system of claim 10, wherein the controller is configured to generate a field map based on the one or more first soil parameters and the one or more second soil parameters.

13. The control system of claim 10, wherein the first sensor comprises a non-contact sensor, the second sensor comprises a non-contact sensor, or a combination thereof.

14. The control system of claim 10, wherein the controller is configured to:
control the first seed flowrate based on the one or more first soil parameters at the first row unit while metering the first seed from the first seed meter is engaged;
control the second seed flowrate based on the one or more second soil parameters at the second row unit while metering the first seed from the second seed meter is engaged;
control the third seed flowrate based on the one or more second soil parameters at the first row unit while metering the second seed from the third seed meter is engaged; and
control the fourth seed flowrate based on the one or more second soil parameters at the second row unit while metering the second seed from the fourth seed meter is engaged.

15. The control system of claim 10, wherein the one or more first soil parameters and the one or more second soil parameters comprise moisture, texture, pH, cation exchange capacity, organic matter, compaction, residue levels, salinity, temperature, or any combination thereof.

16. The control system of claim 10, wherein the first sensor is mounted on a ground-engaging tool of the first row unit, and the second sensor is mounted on a ground-engaging tool of the second row unit.

17. An agricultural system, comprising:
one or more sensors configured to be mounted on the agricultural system, wherein each sensor of the one or more sensors is configured to output a sensor signal indicative of one or more soil parameters;
a first seed meter configured to meter a first seed from a first seed storage tank into a primary line at a first seed flowrate, wherein the primary line is configured to convey the first seed toward a row unit via an airflow through the primary line;
a second seed meter configured to meter a second seed, different from the first seed, from a second seed storage tank into the primary line at a second seed flowrate, wherein the primary line is configured to convey the second seed toward the row unit via the airflow through the primary line;
a row unit, comprising:
a ground engaging tool configured to apply a downward force on a field; and
a packer wheel configured to apply a packing force on the field, wherein an adjustment assembly is configured to control the packing force applied on the field; and
a controller communicatively coupled to the one or more sensors, to the first seed meter, to the second seed meter, and to the adjustment assembly, wherein the controller comprises a processor and a memory, and the controller is configured to:
receive the sensor signal from each sensor of the one or more sensors;
determine the one or more soil parameters based on each sensor signal;
control the first and second seed meters to engage metering of one of the first seed or the second seed and disengage metering of the other of the first seed or the second seed based on the one or more soil parameters.

18. The agricultural system of claim 17, comprising a fertilizer meter configured to meter fertilizer from a fertilizer storage tank into the primary line at a fertilizer flowrate, wherein the controller is communicatively coupled to the fertilizer meter, and the controller is configured to control the fertilizer flowrate based on the one or more soil parameters.

19. The agricultural system of claim 17, wherein the controller is configured to control the adjustment assembly to control the packing force based on the one or more soil parameters.

20. The agricultural system of claim 17, wherein the one or more sensors comprise:
a first sensor mounted on the ground-engaging tool; and
a second sensor mounted on an agricultural seeding implement of the agricultural system; or
any combination thereof.
